(19) United States
(12) Patent Application Publication
(10) Pub. No.: US 2022/0016810 A1
(43) Pub. Date: Jan. 20, 2022

(54) METHOD OF MAKING THERMOSET COMPOSITE RESIN COMPOUNDS FOR DIRECT OVERMOLDING OF SUCKER ROD PROTECTION COMPONENTS

(71) Applicant: Black Mamba Rod Lift, LLC, Oklahoma City, OK (US)

(72) Inventors: Jonathan R. Martin, Edmond, OK (US); William Bruce Hudson, Edmond, OK (US)

(73) Assignee: Black Mamba Rod Lift, LLC, Oklahoma City, OK (US)

(21) Appl. No.: 17/377,110

(22) Filed: Jul. 15, 2021

Related U.S. Application Data
(60) Provisional application No. 63/052,314, filed on Jul. 15, 2020.

(51) Int. Cl. B29C 35/02; F04B 47/02

(52) U.S. Cl. CPC B29C 35/02; B29K 2101/10; F04B 47/026

(57) ABSTRACT

A new method of curing polymer thermoset materials for use in down-hole production system sucker rod protection devices is disclosed. The process for making sucker rod components on a sucker rod comprises the steps of introducing a thermoset molding compound into a molding tool heated to a first temperature; heating the molding compound in the molding tool for a first processing time to form molded sucker rod components on a sucker rod that are partially cured; removing the molded sucker rod components and sucker rod after the first processing time; and placing the sucker rod components and sucker rod into a thermal chamber at a second temperature for a second processing time to provide secondary curing.

### CROSS REFERENCE TO RELATED APPLICATIONS

This application claims the benefit of U.S. provisional application No. 63/052,314 entitled “Improved Method of Making Thermoset Composite Resin Compounds for Direct Overmolding of Sucker Rod Protection Components,” filed Jul. 15, 2020, the contents of which are incorporated herein by reference.

### BACKGROUND OF THE INVENTION

### Field of the Invention

The present invention relates in general to sucker rods for down-hole well pumps artificially lifting fluid from wells, and in particular to methods of manufacturing sucker rod guides and centralizers which prevent sucker rod buckling or rod-on-tubing wear, bending moments and premature failure of sucker rods by wear, abrasion or bending moments.

### Description of the Related Art

For decades, the industry in artificial lift and sucker rod centralizers has preferred thermoplastic processing. Its rapid production times and repeatability is preferred for simplified manufacturing. However, this way of production can produce inferior parts, filled with voids, porous, and requiring higher cost material compounds for suitable use in down-hole environments. For instance, the industry preferred Nylon for years. However, Nylon is hygroscopic and absorbs water, instantaneously reducing its Glass Transition Temperature (Tg) to sub-zero degree Celsius values. Therefore, the strength and modulus of Nylon is drastically reduced and parts reach failure or end-of-life at drastically increased rates.

A movement to performance nylon (PPA—polyphathalamide) was observed with better results. However, resin suppliers continuously frown upon recommendation of PPA for continuous immersion service due to its drastic reduction in strength from its hygroscopic nature.

PPS (polyphenylene sulfide) resin is a fantastic thermoplastic for down-hole use. It is impervious to immersion service and maintains good strength at elevated temperatures. However, it is a thermoplastic, and the Glass Transition Temperature (Tg) continues to negatively affect the integrity of the parts and products made from PPS. Material costs relative to Nylon and PPA are significantly higher.

Phenolics were introduced for use as sucker rod centralizers in U.S. Pat. No. 9,869,135. Because phenolics are of the thermoset family, special attention must be paid to curing times, temperatures, and pressures to mold quality, suitable parts for down-hole use. The focus of the cited patent is on phenolic sucker rod guides and a recommended manufacturing layout for overcoming the longer cycle times of manufacturing relative to that of thermoplastic sucker rod guides manufactured by way of multiple presses. The sucker rod centralizer in the cited patent specifically references phenolic molding of the same legacy product which has existed for over half a century.

Because of the recognized disadvantages with thermoplastics and limitations in processing of phenolic resins for sucker rod and centralizer assemblies, there is room for improvement in the manufacturing techniques employed for such products.

### BRIEF DESCRIPTION OF THE DRAWING

FIG. 1 is an outline of an example process that can be carried out in accordance with a preferred embodiment of the present invention.

### DETAILED DESCRIPTION

Certain embodiments of the present invention relate to new processes for manufacturing sucker rod centralizers. Certain embodiments include improved manufacturing process and equipment to accommodate these new resin systems, and the resin system itself has been improved to work acceptably with the over-molding and attachment to sucker rods.

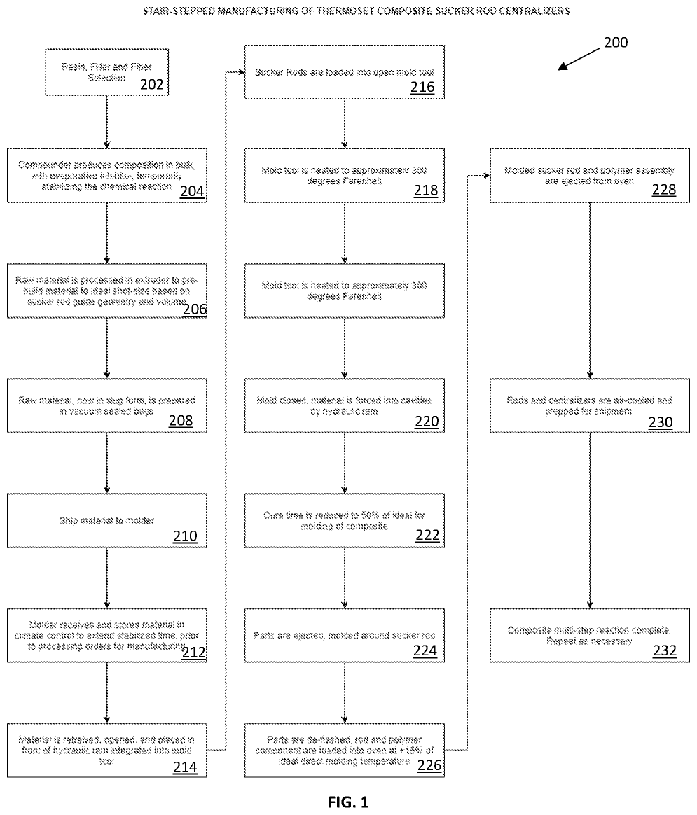

As summarized in the generalized process outline 200 shown in FIG. 1, the process begins at step 202 with the material supplier selecting and compounding a thermoset resin composition containing potentially various fibers and/or mineral, organic, or inorganic fillers, compounded to the specific needs of both the molder and sucker rod product manufacturer. Suitable resin materials include, without limitation, unsaturated polyester, isophthalic polyester, vinylester, epoxy or a mixture of the foregoing. Polyester and vinylester resins are particularly preferred for ease of processability and temperature, chemical, and immersion service compatibility. Diallyl phthalate (DAP), Diallyl iso-phthalate are also suitable thermoset resins which can benefit from this process. As shown in step 204, an inhibitor chemical is also added to the resin, fiber, and fillers as part of the composition. Its purpose is to prevent the natural chemical reaction of the thermoset resin from occurring, pausing the resin's tendency to begin to crosslink until the manufacturer is ready to process the material, turning it into final sucker rod centralizer form. Suitable inhibitors may include, without limitation, hydroquinone and tertiary butyl catechol (TBC). These raw materials are mixed in a large blender, creating a uniform molding compound in bulk form.

In step 206, the molding compound is then transferred into a stuffer unit, which, through mechanical force, packs the molding compound into the feed throat of an extrusion machine. The feed-throat accepts the molding compound, and the reciprocating screw by way of rotation and backpressure, prepares “slugs” of molding compound at room temperature in the desired “shot-size.” No heat is applied to the compound during this part of the process. The design of the molded, finished parts dictates the diameter and length of the cylindrically shaped slugs of molding compound. It shall be understood that the extruded form of this molding compound is for preference, and it is not a required and necessary step to successfully process materials. Other ways to mold these composite compounds include weighing out the appropriate shot size, as long as the part volume and specific gravity of the molding compound(s) are known.

The slugs of material are ejected from the extruder and cut to length. From there, the slugs of molding compound are packaged in sealed bags in step 208, limiting the molding compound's exposure to air and to further inhibit the natural chemical reactions of the thermoset resin. It is important to ensure that the inhibitor does not evaporate before the slugs are sealed in vapor barrier bags, or the processing time of the thermoset resin compound will begin, curing the molding compound. The slugs are then packaged and shipped to the molder in step 210.

In step 212, the manufacturer of the sucker rod centralizer receives the material, storing it appropriately for optimization of processing and shelf-life. Ideally, the material's temperature is held in a controlled environment in effort to preserve the calculated and tuned processing and flow as designed for the manufacturer's specific needs.

In step 214, the manufacturer feeds slugs of molding compound to a mechanical press which is integrated with the molding tool. This press could be electric, air or hydraulically actuated for mechanical force. The sucker rod “insert” is loaded into the open mold tool in step 216 which is specifically designed to freely accommodate the insert (the sucker rod). The molding press and tool should be able to flow material and hold temperature, pressure, and time. The mold tool is heated to approximately 280-350 degrees Fahrenheit in step 218, the mold is closed and material is forced into the mold cavities by the mechanical system or press in step 220.

Once the vapor barrier sealed bags are opened, slugs of molding material should be processed quickly as the inhibitor begins to evaporate as soon as the molding compound is open to ambient air, causing the molding compound to begin to advance toward cure. The processing cycle times of molding can be adjusted for a given temperature. For instance, an increase in the temperature of the material will reduce the time to cross-link and cure the composite. Prior art methods would typically allow sufficient processing time in the molding tool for the product to be formed on the sucker rod insert and cured inside the tool. However, in accordance with the present invention, the product is given a shorter treatment cycle and is not allowed to fully cure inside the molding tool. This allows for the product to be removed from the molding tool more quickly and increases the output of the molding tool. Processing times for this step will range from 45 seconds after the molding compound has filled the mold cavities, to 75 seconds or beyond, at temperatures from 280° F. to 350° F., with a presently preferred temperature of about 330° F., as shown in step 218. Geometrical advantages and dimensional reduction of cross-sections of polymer product around the sucker rod, to which adhesion is directly attributed to and is the most critical area of the molded assembly, can further allow a reduction of time requirement in the tool. By contrast, non-optimized geometry with standard cycle times for curing thermoset resins at the mold for sucker rod components are between 150 and 200 seconds. Larger cross-section parts require the longer cure cycles. As shown in step 222, the processing times of the present invention represent a substantial reduction in time, approximately 50% in some embodiments, over prior art techniques given the large cross-section and wall thickness of the polymer sucker rod product.

Once the rods are ejected in step 224 with the molded centralizers, they are de-flashed, and then further cured in a thermal chamber, which can be an oven as shown in step 226. Additional heating can optionally be supplied to the oven to maintain the temperature of the oven above 280 degrees Fahrenheit, the minimum ideal mold temperature. In one embodiment, the temperature for this second stage curing is about 115% of the molding temperature. Alternatively, the thermal chamber can be any compartment or container that is insulated in such a way as to slow the cooling of the sucker rods and sucker rod components formed thereon. In this embodiment, the hot sucker rods and sucker rod components are allowed additional curing time in the thermal chamber without providing an additional heat source. Secondary cooling time in the thermal chamber will vary depending on geometry and thickness of the components, but it has been found that about 15-30 minutes of additional curing time is presently preferred for most components. Obviously, longer cooling times can be used consistent with the present invention. Providing this separate curing cycle in a thermal chamber allows more time at temperature to cure the thermoset resin and increase its strengths and shrinkage, successfully bonding the composite centralizer to the sucker rod with far greater adhesion than that of prior art thermoplastic processing methods in the sucker rod industry. Without a more complete cure of thermoset resin, the material's integrity is greatly reduced, and failures have been observed in application directly related to this. The additional cure time by way of this secondary cure process allows for greatly extended cure-times (i.e., “cure insurance”), preventing the possibility of shipping thermoset parts which may not be cured sufficient for use.

Once fully cured, the molded sucker rod and polymer assembly are ejected from the thermal chamber in step 228 and air-cooled and prepared for shipment in step 230. This process can repeated, as shown in step 232.

As an example, an industry standard PPS resin sucker rod guide with glass and mineral filler is 8.25 inches in length. This material is a thermoplastic, with a Glass Transition Temperature of approximately 210° Fahrenheit. The shrinkage bonding of a very well molded part to a sucker rod section at room temperature is consistently in the range of 7,500 pounds-force. This force in industry is understood as the force to displace the sucker rod through the guide, while holding the guide still, and is a direct measurement as to the friction and shrink fit of the plastic centralizer to the sucker rod guide. This method of adhesion verification for quality assurance and quality control has been a standard analysis method for decades with all sucker rod guide or centralizer manufacturers. When the PPS part is heated to a reasonable application temperature, 200° Fahrenheit, the adhesion to the bar reduces substantially due to the material's coefficient of thermal expansion (CTE). These growth rates and CTE values are not linear. In fact, the expansion rate of the PPS molded part increases drastically after the plastic's temperature breaches the Tg value. The Tg value can change and is not the same from part to part. Cross-link density, molding conditions, times and temperatures during processing are all very important in the crystallization of the thermoplastic semi-crystalline polymer, setting the Tg value for that specific part. The push-test value of the largest PPS product on the market is reduced by 70%, down to below 2,200 pounds-force. There is a tendency for these sucker rod guides to slip along the rod in elevated temperature and under a variety of loads.

By utilizing the process and invention disclosed herein, the post baking cycle and manufacturing facility can continuously cure and stabilize thermoset resins for an extended period of time, all the while machine investment and cycle times at the molding press can be limited. Thus, plastics can be processed to align their molecular structure for increased or specifically desired properties and performance. By shifting the cure cycle from one cell (the molding press) to a secondary, dedicated operation (the post-curing thermal chamber), production throughput can be increased substantially.

A cure time at the molding press can be limited to the formation of a solid polymer product. Under further evaluation, the reduced cycle time may produce a part which is not cured or featuring the ideal cross-link density. The secondary baking operation exposes and sustains the rod and polymer to substantially increased times within the required curing temperature range and allows for the structure of the resin to better polymerize and cross-link, increasing its strength of bond to the sucker rod.

For instance, a study was conducted with specific molding tools to understand the relationship of cure times at the press, along with reduced cure times at the press and no-post baking, in addition to reduced cure times at the press along with an extended secondary cure cycle directly after molding.

An average value is shown below. Sample size for each Sample No. is 4 pieces. Generalized results are shown in the table below.

| | | Wall- | Molding | | |
|---|---|---|---|---|---|
| | Length | Thickness | Time | 60 Min Post- | Adhesion @ |
| Sample No. | (inches) | (inches) | (Seconds) | Bake? | 200° F |
| 1 | 2″ | 3/16″ | 90 | N | 500 |
| 2 | 4″ | 3/16″ | 90 | N | 900 |
| 3 | 6″ | 3/16″ | 90 | N | 1,600 |
| 4 | 2″ | 1/4″ | 90 | N | 800 |
| 5 | 4″ | 1/4″ | 90 | N | 1,600 |
| 6 | 6″ | 1/4″ | 90 | N | 2,200 |
| 7 | 2″ | 3/16″ | 180 | N | 900 |
| 8 | 4″ | 3/16″ | 180 | N | 1,400 |
| 9 | 6″ | 3/16″ | 180 | N | 2,000 |
| 10 | 2″ | 1/4″ | 180 | N | 1,100 |
| 11 | 4″ | 1/4″ | 180 | N | 2,400 |
| 12 | 6″ | 1/4″ | 180 | N | 2,800 |
| 13 | 2″ | 3/16″ | 90 | Y | 1,900 |
| 14 | 4″ | 3/16″ | 90 | Y | 2,600 |
| 15 | 6″ | 3/16″ | 90 | Y | 2,900 |
| 16 | 2″ | 1/4″ | 90 | Y | 1,700 |
| 17 | 4″ | 1/4″ | 90 | Y | 2,800 |
| 18 | 6″ | 1/4″ | 90 | Y | 3,200 |
| 19 | 2″ | 3/16″ | 180 | Y | 1,600 |
| 20 | 4″ | 3/16″ | 180 | Y | 2,200 |
| 21 | 6″ | 3/16″ | 180 | Y | 3,200 |
| 22 | 2″ | 1/4″ | 180 | Y | 1,800 |
| 23 | 4″ | 1/4″ | 180 | Y | 2,500 |
| 24 | 6″ | 1/4″ | 180 | Y | 3,500 |

This limited experiment proves that post-baking part sections have a noticeable improvement for adhesion to the bar for the pre-made thermoset composite slugs. Therefore, it is advantageous and encourages the use of the modified process for supplying the industry an appropriate product with greater reliability in staying attached to the sucker rod, with a reduced TAKT time (bottle-neck cycle time). The adhesion values, when extrapolated out for bonding surface area and increased thickness in the 8.25″ PPS sucker rod guide discussed earlier, far exceed that of the industry's most common sucker rod guide currently offered.

Material costs between PPS and the stair-stepped cure process of the thermoset composite resins prove the invention and process herein are much lower on a per unit basis, for higher performance and greater reliability. Thermoset resins are generally preferred for immersion service, elevated temperature service, and chemical resistance thanks to their cross-linked polymer and molecular bonding. Capital expenditures are required in order to process and manufacture sucker rod guides for this invention, however, the long-term reward makes this a highly desirable process.

With the new and improved processing for the manufacturing of sucker rod guides, centralizers, or stabilizers, end-users can extract benefits of thermoset resins for down-hole use. The manufacturer can process what is typically viewed as a timely, complicated chemical reaction process in multiple steps in an effort to drastically reduce labor costs and long-cycle times which limit throughput. Thus, the advantages of this invention provide a manufacturing process for molding a thermoset composite ready-made and featuring a stabilizing inhibitor, for transfer molding sucker rod protection devices, guides, centralizers or stabilizers (collectively “sucker rod components). The stair-stepped manufacturing method allows for drastically reduced cycle times with the advantageous properties necessary for direct bonding of the thermoset composites to the sucker rod. The processing of the pre-made thermoset composite resins not of phenol-formaldehyde proves advantageous for cost. However, various steps in manufacturing can be manipulated to allow for the same outcome with a reduction of benefit in another. For example, the secondary thermal chamber can be bypassed to save capital expenditures; however the stabilizer and inhibitor containing resin must be molded for a longer cycle time at the press. If a shorter cycle time occurs, a reduction in polymer-to-sucker rod bonding will be realized. The stair-stepped curing process can also be applied to phenol-formaldehyde resins, though the material compounds costs are higher than ready-made bulk molding compounds.

Although the preferred embodiment has been described in detail, it should be understood that various changes, substitutions, and alterations can be made therein without departing from the spirit and scope of the invention as defined by the appended claims.

What is claimed is:

1. A process for making sucker rod components on a sucker rod comprising:
introducing a thermoset molding compound into a molding tool heated to a first temperature;
heating the molding compound in the molding tool for a first processing time to form molded sucker rod components on a sucker rod that are partially cured;
removing the molded sucker rod components and sucker rod after the first processing time; and
placing the sucker rod components and sucker rod into a thermal chamber at a second temperature for a second processing time to provide secondary curing.

2. The process of claim 1, wherein the first processing time is from about 45 to about 75 seconds.

3. The process of claim 2, wherein the first temperature is from about 280° F. to 350° F.

4. The process of claim 3, wherein the first temperature is about 330° F.

5. The process of claim 3, wherein the thermal chamber is an oven.

6. The process of claim 5, wherein the second temperature is at least 280° F.

7. The process of claim 3, wherein the thermal chamber is an insulated container.

8. The process of claim 7 wherein the second temperature is at least 280° F.

9. The process of claim 3, wherein the second processing time is at least 15 minutes.

10. A process for making a sucker rod component on a sucker rod comprising:
introducing a thermoset molding compound into a molding tool heated to a first temperature of from about 280° F. to 350° F.;
heating the molding compound in the molding tool for a first processing time of from about 45 to about 75 seconds to form a molded sucker rod component on a sucker rod that is partially cured;
removing the molded sucker rod component and sucker rod after the first processing time; and
placing the sucker rod component and sucker rod into thermal chamber at a second temperature for a second processing time to provide secondary curing.

11. The process of claim 10, wherein the first temperature is about 330° F.

12. The process of claim 10, wherein the second temperature is at least 280° F.

13. The process of claim 10, wherein the thermal chamber is an oven.

14. The process of claim 10, wherein the thermal chamber is an insulated container.

15. A molded sucker rod component and sucker rod produced by:
introducing a thermoset molding compound into a molding tool heated to a first temperature of from 280° F. to 350° F.;
heating the molding compound in the molding tool for a first processing time of from 45 to 75 seconds to form a molded sucker rod component on a sucker rod that is partially cured;
removing the molded sucker rod component and sucker rod after the first processing time; and
placing the sucker rod component and sucker rod into a thermal chamber at a second temperature for a second processing time to provide secondary curing.

16. The molded sucker rod component and sucker rod of claim 15, wherein the first temperature is about 330° F.

17. The process of claim 15, wherein the second temperature is at least 280° F.

18. The process of claim 15, wherein the molded sucker rod component and sucker rod are deflashed before being placed into the thermal chamber.
